(19) United States
(12) Patent Application Publication
(10) Pub. No.: US 2015/0108097 A1
(43) Pub. Date: Apr. 23, 2015

(54) LASER WELDING OF NICKEL-BASED SUPERALLOYS

(71) Applicants: SIEMENS AKTIENGESELLSCHAFT, München (DE); FRAUNHOFER GESELLSCHAFT ZUR FÖRDERUNG DER ANGEWANDTEN FORSCHUNG, München (DE)

(72) Inventors: Nikolai Arjakine, Berlin (DE); Bernd Burbaum, Falkensee (DE); Andres Gasser, Aachen (DE); Torsten Jokisch, Neuenhagen bei Berlin (DE); Stefanie Linnenbrink, Kreuzau (DE); Frank Mentzel, Aachen (DE); Michael Ott, Mulheim an der Ruhr (DE); Norbert Pirch, Aachen (DE)

(73) Assignees: SIEMENS AKTIENGESELLSCHAFT, München (DE); FRAUNHOFER GESELLSCHAFT ZUR FÖRDERUNG DER ANGEWANDTEN FORSCHUNG, München (DE)

(21) Appl. No.: 14/371,496

(22) PCT Filed: Dec. 4, 2012
(86) PCT No.: PCT/EP2012/074310

§ 371 Date: Jul. 10, 2014

(30) Foreign Application Priority Data
Jan. 10, 2012 (EP) 12150579.6

(51) Int. Cl. B23K 26/32; B23K 26/34

(52) U.S. Cl. CPC B23K 26/3213; B23K 26/345
USPC 219/76.14

(57) ABSTRACT

In order to obtain crack-free, homogeneous welds in nickel-based superalloys, laser parameters in respect of the power, the beam diameter, the mass feed rate, and the speed of advancement, are specifically selected.

### CROSS-REFERENCE TO RELATED APPLICATIONS

The present application is a 35 U.S.C. §§371 national phase conversion of PCT/EP2012/074310, filed Dec. 4, 2012, which claims priority of European Patent Application No. 12150579.6, filed Jan. 10, 2012, the contents of which are incorporated by reference herein. The PCT International Application was published in the German language.

### TECHNICAL BACKGROUND

The invention relates to the laser welding of nickel-based substrates by means of a laser, with a welding material being applied to a substrate to effect the weld in the substrate.

The welding of materials sometimes leads to cracks. A welded joint or build-up welding of this nature then does not satisfy the required demands. It is an object of the invention to solve this problem.

### SUMMARY OF THE INVENTION

The object is achieved by a laser build-up welding process according to the invention. The improvement concerns a laser build-up welding process described in more detail below, including a laser beam of specified parameters, a mass feed rate of welding powder, setting the speed of the laser over the substrate being welded, displacing the laser beam and selection of an appropriate nickel-based superalloy for being welded with a selected high γ′ content

### BRIEF DESCRIPTION OF THE DRAWINGS

In the drawing:

FIG. 1 schematically shows an apparatus which is used to carry out the laser build-up welding process,

FIG. 2 shows a list of superalloys.

### DESCRIPTION OF AN EMBODIMENT

The figure and the description represent merely exemplary embodiments of the invention.

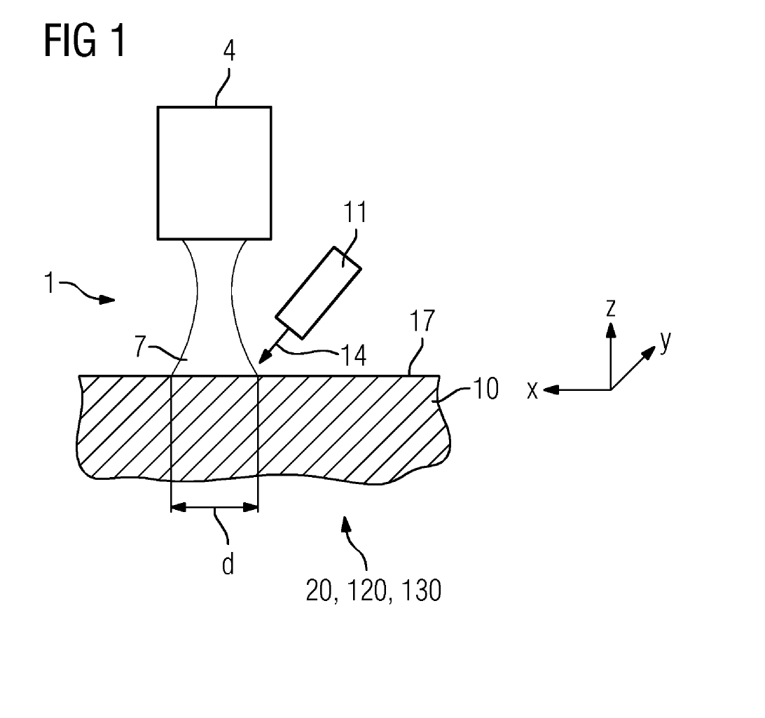

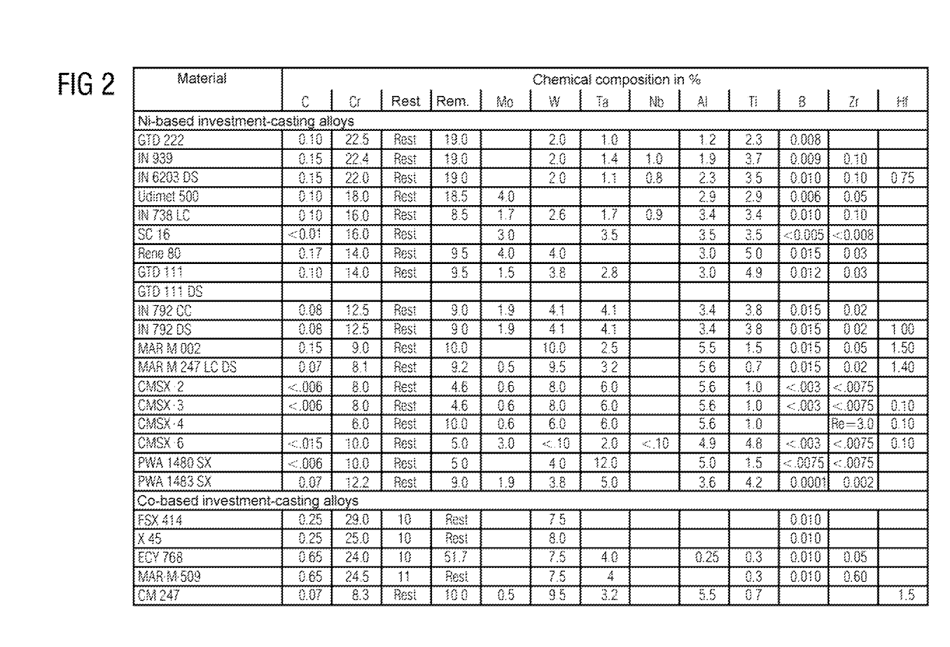

FIG. 1 shows a component 20, 120, 130 having a substrate 10 which comprises a nickel-based alloy, in particular an alloy as shown in FIG. 2.

Welding material 14, that is, welding powder, is applied to the surface 17 of the substrate 10, if appropriate at an excavated point. The welding powder may be any nickel-based superalloy powder, typically used for gas turbines. Melting depressants, such as boron or silicone, may be added. The welding powder may also be the material of which the substrate being welded is comprised.

This is done by means of a laser 4, which uses a laser beam 7 to melt the material 14 coming from a material feed 11, in particular a powder feed. In this process, the laser 4 preferably moves at a speed of 500 mm/min. The laser power is preferably 80 watts to 120 watts, in particular 100 watts. The laser beam 7 of the laser 4 has a concave curvature.

The laser beam is conical typically. The laser beam diameter d is preferably between 300 μm and 400 μm, in particular 350 μm. The laser beam diameter d is measured on the surface 17.

In order to generally keep the supply of heat into the substrate 10 low, use is preferably made of a low mass feed rate of the powder of between 360 mg/min and 450 mg/min, in particular between 370 mg/min and 390 mg/min.

Accordingly, the speed of movement of the laser beam 7 over the substrate or surface 17 is 450 mm/min to 550 mm/min. The speed and mass feed rate of powder are coordinated to provide sufficient time to melt the powder and optionally to melt the surface layer of the substrate.

By virtue of these laser parameters, the power, the beam diameter, the speed of movement and the mass feed rate, the input of energy is deliberately kept low in order to avoid thermal cracks.

Cracks in welding layers lying one above another can also be avoided by further measures.

Firstly, this is done by virtue of the fact that the welding tracks which are laid alongside one another and form a welding layer lie between 200 μm and 250 μm apart, that is to say the laser is displaced by this amount AY in the Y direction in the plane of the welding layer to move from one track formed to the next, adjacent track to be formed.

For the subsequent welding layer, that is to say for increasing the thickness, the focus position dz is displaced by 100 μm to 150 μm in the Z direction.

These measures avoid thermal stresses and therefore also weld-related cracks.

The substrate 10 is preferably welded at below 100° C., preferably at room temperature, particularly so that cooling, very particularly without control, is carried out.

This procedure/these measures are particularly suitable for nickel-based alloys having a high γ′ content. γ′ is a secondary phase known in nickel-based super alloys. The content of a γ′ phase is the content of this phase rated to the volume or mass fraction of the matrix in which the γ′ phase is incorporated. This procedure is in particular for substrates made of Rene 80 or of 1N738, both known in the art, since these are materials which are generally somewhat harder to weld.

The high γ′ content is considered to be the maximum γ′ content at room temperature.

This γ′ content is preferably at least 30% by weight, in particular in the range of between 30% by weight and 50% by weight, very particularly 35% by weight.

The γ′ proportion in the alloy is brought about by titanium (Ti) and aluminum (Al), and therefore it is preferable that the contents of titanium (Ti) and aluminum (Al) together are preferably between 7% by weight and 9% by weight, in particular 8% by weight.

A carbon content (C) of the nickel-based superalloy is between 0.15% and 2.5% by weight and particularly 0.17% by weight.

The process can similarly be employed for nickel-based alloys having a relatively high carbon content of 0.15% by weight to 0.25% by weight.

The foregoing procedures/measures produce, for example, a polycrystalline weld seam.

1. A laser build-up welding process for a substrate of a nickel-based superalloys,
using a laser which generates a laser beam having a diameter (d) of the laser beam with a diameter of 300 μm to 400 μm, the process comprising:
feeding a welding powder at a mass feed rate between 360 mg/min and 450 mg/min,
optionally at least one of setting the laser power between 80 watts and 120 watts; and
setting the speed of movement between the substrate and the laser beam at 450 mm/min to 550 mm/min;
and displacing by an amount of 200 μm to 250 μm in a welding layer plane, in order to produce a directly adjacent welding track, for thereby producing a plurality of the welding tracks arranged alongside one another for producing a welding layer.

2. The process as claimed in claim 1, in which the laser power is between 80 watts and 120 watts.

3. The process as claimed in claim 1, wherein the mass feed rate is between 360 mg/min and 450 mg/min.

4. The process as claimed in claim 1, wherein the speed of movement between the substrate and the laser beam is 450 mm/min to 550 mm/min.

5. The process as claimed in claim 1, wherein the laser is displaced by an amount of 200 μm to 250 μm in a welding layer plane in order to produce a directly adjacent welding track, wherein a plurality of the welding tracks arranged alongside one another produce a welding layer.

6. The process as claimed in claim 5, wherein the laser is displaced by 100 μm to 150 μm in the Z direction in order to produce a new welding layer.

7. The process as claimed in claim 1, wherein the welding material used is the material of the substrate.

8. The process as claimed in claim 1, wherein the welding is carried out at a substrate temperature of below 100° C.

9. The process as claimed in claim 1, wherein nickel-based alloys having a high γ′ content are welded, in particular having a γ′ content of 30% by weight to 50% by weight.

10. The process as claimed in claim 9, wherein a titanium and an aluminum content (Ti+Al) of the nickel-based superalloy together is between 7% by weight and 9% by weight.

11. The process as claimed in claim 1, wherein a carbon content (C) of the nickel-based superalloy is between 0.15% by weight and 2.5% by weight.

12. The process as claimed in claim 1, configured such that a polycrystalline weld seam is produced.

13. The process as claimed in claim 1, the welding is carried out on IN738.

14. The process as claimed in claim 1, wherein the welding is carried out on Rene 80.
